(19) United States
(12) Patent Application Publication
(10) Pub. No.: US 2025/0254590 A1
(43) Pub. Date: Aug. 7, 2025

(54) MOBILITY MANAGEMENT METHOD AND APPARATUS, AND DEVICE AND STORAGE MEDIUM

(71) Applicant: Beijing Xiaomi Mobile Software Co., Ltd., Beijing (CN)

(72) Inventor: Xing YANG, Beijing (CN)

(73) Assignee: Beijing Xiaomi Mobile Software Co., Ltd., Beijing (CN)

(21) Appl. No.: 18/856,313

(22) PCT Filed: Apr. 13, 2022
(86) PCT No.: PCT/CN2022/086718

§ 371 Date: Oct. 11, 2024

(51) Int. Cl. H04W 36/30; H04W 36/00

(52) U.S. Cl. CPC H04W 36/30; H04W 36/0083

(57) ABSTRACT

A mobility management method performed by a terminal device includes: receiving first configuration information, the first configuration information comprising a beam identifier; determining, according to the beam identifier, a beam to be measured; measuring said beam to obtain a beam measurement result; and triggering measurement reporting or handover according to the beam measurement result and a result threshold value.

### CROSS-REFERENCE TO RELATED APPLICATIONS

The present application is a U.S. National Stage of International Application No. PCT/CN2022/086718, filed on Apr. 13, 2022, the disclosure of which is incorporated herein by reference in its entirety for all purposes.

### TECHNICAL FIELD

The present disclosure relates to the field of communication technology, and in particular to a mobility management method and apparatus, a device and a storage medium.

### BACKGROUND

In communication systems, a network device could instruct a terminal device to perform cell handover or beam handover to improve communication performance of the terminal device, and the handover depends on measurement results reported by the terminal device. The ways in which the terminal device report measurement results can be divided into periodic reporting and event reporting.

In related art, the measurement results reported by the terminal device are cell measurement results.

In this way, a calculation process for the cell measurement results needs to be filtered by Layer 3 (a radio resource control layer and a non-access stratum).

### SUMMARY

Embodiments of the present disclosure provide a mobility management method and apparatus, a device, a chip system, a storage medium, a computer program and a computer program product, which can be applied in the field of communication technology.

In a first aspect, an embodiment of the present disclosure provides a mobility management method, applied to a terminal device, the method including: receiving first configuration information, where the first configuration information includes a beam identifier; determining a beam to be measured based on the beam identifier; performing measurement on the beam to be measured to obtain a beam measurement result; and triggering measurement reporting or handover based on the beam measurement result and a result threshold.

In a second aspect, an embodiment of the present disclosure provides another mobility management method, which is applied to a network device, and the method includes: sending first configuration information to a terminal device, where the first configuration information includes a beam identifier; in response to measurement reporting or handover by the terminal device, triggering cell handover for the terminal device; where the measurement reporting or handover is triggered by the terminal device based on a beam measurement result and a result threshold, the beam measurement result is obtained by performing measurement on a beam to be measured by the terminal device, and the beam to be measured is determined from the beam identifier.

In a third aspect, an embodiment of the present disclosure provides a mobility management apparatus, which can implement some or all of the functions of the terminal device in the method of the first aspect described above. For example, the functions of the mobility management device may have the functions of some or all of the embodiments in the present disclosure, or may have the function of implementing any one of the embodiments in the present disclosure alone. The functions may be implemented by hardware, or by hardware executing corresponding software. The hardware or software includes one or more units or modules corresponding to the above functions.

In an embodiment of the present disclosure, the structure of the mobility management apparatus may include a transceiving module and a processing module, and the processing module is configured to support the mobility management apparatus to perform the corresponding functions in the above method. The transceiving module is configured to support communication between the mobility management apparatus and other devices. The mobility management apparatus may further include a storage module, which is configured to be coupled with the transceiving module and the processing module, and to store necessary computer programs and data of the mobility management apparatus.

In a fourth aspect, an embodiment of the present disclosure provides another mobility management apparatus, which can implement some or all of the functions of the network device in the method example of the second aspect described above. For example, the functions of the mobility management apparatus may have some or all of the functions in the embodiments of the present disclosure, or may have the functions of implementing any one of the embodiments of the present disclosure alone. The functions may be implemented by hardware, or by hardware executing corresponding software. The hardware or software includes one or more units or modules corresponding to the above functions.

In an embodiment of the present disclosure, the structure of the mobility management apparatus may include a transceiving module and a processing module, and the processing module is configured to support the mobility management apparatus to perform the corresponding functions in the above method. The transceiving module is configured to support. the communication between the mobility management apparatus and other devices. The mobility management apparatus may further include a storage module, which is configured to be coupled with the transceiving module and the processing module, and to store necessary computer programs and data of the mobility management apparatus.

In a fifth aspect, an embodiment of the present disclosure provides a communication apparatus, including a processor which, when calling a computer program in a memory, performs the mobility management method in the first aspect described above.

In a sixth aspect, an embodiment of the present disclosure provides a communication apparatus, including a processor which, when calling a computer program in a memory, performs the mobility management method in the second aspect described above.

In a seventh aspect, an embodiment of the present disclosure provides a communication apparatus, including a processor and a memory, where the memory stores a computer program, and the processor executes the computer program stored in the memory to cause the communication apparatus to perform the mobility management method in the first aspect described above.

In an eighth aspect, an embodiment of the present disclosure provides a communication apparatus, including a processor and a memory, where the memory stores a computer program, and the processor executes the computer program stored in the memory cause the communication apparatus to perform the mobility management method in the second aspect described above.

In a ninth aspect, an embodiment of the present disclosure provides a communication apparatus, which includes a processor and an interface circuit, where the interface circuit is configured to receive code instructions and transmit the code instructions to the processor, and the processor is configured to run the code instructions to cause the apparatus to perform the mobility management method in the first aspect described above.

In a tenth aspect, an embodiment of the present disclosure provides a communication apparatus, which includes a processor and an interface circuit, where the interface circuit is configured to receive code instructions and transmit the code instructions to the processor, and the processor is configured to run the code instructions to cause the apparatus to perform the mobility management method in the second aspect described above.

In an eleventh aspect, an embodiment of the present disclosure provides a communication system, the system including the mobility management apparatus described in the third aspect and the mobility management apparatus described in the fourth aspect, or the system including the communication apparatus described in the fifth aspect and the communication apparatus described in the sixth aspect, or the system including the communication apparatus described in the seventh aspect and the communication apparatus described in the eighth aspect, or the system including the communication apparatus described in the ninth aspect and the communication apparatus described in the tenth aspect.

In a twelfth aspect, an embodiment of the present disclosure provides a computer-readable storage medium configured to store instructions used for a terminal device described above, where the instructions, when being executed, causes the terminal device to perform the mobility management method in the first aspect described above.

In a thirteenth aspect, an embodiment of the present disclosure provides a readable storage medium configured to store instructions used for a network device described above, where the instructions, when being executed, causes the network device to perform the mobility management method in the second aspect described above.

In a fourteenth aspect, the present disclosure further provides a computer program product including a computer program which, when being run on a computer, causes the computer to perform the mobility management method in the first aspect described above.

In a fifteenth aspect, the present disclosure further provides a computer program product including a computer program which, when being run on a computer, causes the computer to perform the mobility management method in the second aspect described above.

In a sixteenth aspect, the present disclosure provides a chip system, including at least one processor and an interface, and configured to support a terminal device to implement the functions involved in the first aspect, for example, determining or processing at least one of the data and information involved in the above method.

In a seventeenth aspect, the present disclosure provides a chip system, which includes at least one processor and an interface, and configured to support a network device to implement the functions involved in the second aspect, for example, determining or processing at least one of the data and information involved in the above method.

In an eighteenth aspect, the present disclosure provides a computer program which, when being executed on a computer, causes the computer to perform the mobility management method in the first aspect described above.

In a nineteenth aspect, the present disclosure provides a computer program which, when being executed on a computer, causes the computer to perform the mobility management method in the second aspect described above.

### BRIEF DESCRIPTION OF THE DRAWINGS

In order to more clearly illustrate the technical solutions in the embodiments of the present disclosure or the background technology, the drawings required to be used in the embodiments of the present disclosure or the background technology will be explained below.

FIG. 1 is a schematic diagram of an architecture of a communication system provided by an embodiment of the present disclosure;

FIG. 2 is a flow chart of a mobility management method provided by an embodiment of the present disclosure;

FIG. 3 is a flow chart of another mobility management method provided by an embodiment of the present disclosure;

FIG. 4 is a flow chart of another mobility management method provided by an embodiment of the present disclosure;

FIG. 5 is a flow chart of still another mobility management method provided in an embodiment of the present disclosure;

FIG. 6 is a flow chart of still another mobility management method provided in an embodiment of the present disclosure;

FIG. 7 is a flow chart of still another mobility management method provided in an embodiment of the present disclosure;

FIG. 8 is a flow chart of still another mobility management method provided in an embodiment of the present disclosure;

FIG. 9 is a flow chart of still another mobility management method provided in an embodiment of the present disclosure;

FIG. 10 is a flow chart of yet another mobility management method provided in an embodiment of the present disclosure;

FIG. 11 is a flow chart of yet another mobility management method provided in an embodiment of the present disclosure;

FIG. 12 is a flow chart of yet another mobility management method provided in an embodiment of the present disclosure;

FIG. 13 is a flow chart of yet another mobility management method provided in an embodiment of the present disclosure;

FIG. 14 is a flow chart of yet another mobility management method provided in an embodiment of the present disclosure;

FIG. 15 is a flow chart of yet another mobility management method provided in an embodiment of the present disclosure;

FIG. 16 is a structural schematic diagram of a mobility management apparatus provided in an embodiment of the present disclosure;

FIG. 17 is a structural schematic diagram of another communication apparatus provided in an embodiment of the present disclosure; and

FIG. 18 is a structural schematic diagram of a chip according to an embodiment of the present disclosure.

### DETAILED DESCRIPTION

Illustrative embodiments will be described in detail herein, examples of which are shown in the accompanying drawings. When the following description refers to the drawings, the same numerals in different drawings represent the same or similar elements unless otherwise indicated. The implementations described in the following illustrative embodiments do not represent all implementations consistent with the embodiments of the present disclosure. Instead, they are merely examples of apparatuses and methods consistent with some aspects of the embodiments of the present disclosure as detailed in the appended claims.

The terms used in the embodiments of the present disclosure are only for the purpose of describing specific embodiments and are not intended to limit the embodiments of the present. disclosure. The singular forms of “a” and “the” used in the embodiments of the present disclosure and the appended claims are also intended to include plural forms unless the context. clearly indicates other meanings. It should also be understood that the term “and/or” used herein refers to and includes any or all possible combinations of one or more associated items listed.

It should be understood that although the terms first, second, third, etc. may be used to describe various information in the embodiments of the present disclosure, these information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “at” or “when” or “in response to determining”.

For ease of understanding, the terms involved in the present disclosure are introduced first.

### 1. Mobile Management (MM)

Mobility management refers to a process of managing location information, security, and business continuity of terminal devices. The connection state between terminal devices and network devices can be optimized through the mobility management, thereby providing guarantees for the application of various network services.

### 2. Wave Beam

A beam refers to a shape of an electromagnetic wave emitted by a satellite antenna that is formed on the earth's surface (similar to a beam of light emitted by a flashlight into the dark). Beams can be divided into several types, such as global beams, spot-shaped beams, and beamformed beams, and the shapes of the beams can be determined by the transmitting antenna.

### 3. Measurement Reporting

Measurement reporting refers to a process in which the terminal device uploads the beam measurement result to the network device after obtaining the beam measurement result. The terminal device can perform measurement reporting periodically, or the measurement reporting operation can be triggered by a specific event.

### 4. Cell (Mobile Communication Terminology)

A cell, also called a cellular cell, refers to an area covered by a base station or a part of the base station (a sector-shaped antenna) in a cellular mobile communication system, in which a mobile station can perform reliable communication with the base station through a radio channel. There can be one or more beams in a cell.

### 5. Handover

Handover is one of the measures for performing mobility management by communication systems. In a communication system, the terminal device can perform cell handover or beam handover operations to change the channel used in the communication between the terminal device and the network device.

### 6. Reference Signal

A reference signal refers to a known signal that is transmitted from a transmitter to a receiver and is used for channel estimation or channel detection, In a mobile communication network, the network device usually allocates a portion of the system bandwidth to a specific terminal device. That is, at a specific time, a specific frequency region resource is allocated to the terminal device. In this case, if the network device knows some specific frequency regions with better quality and preferentially allocates them to the terminal device, the service quality of the terminal device will be better guaranteed. In this case, the reference signal can provide reference information for scheduling resource operations of the network device.

In order to better understand a mobility management method disclosed in an embodiment of the present disclosure, a communication system to which the embodiment of the present disclosure is applicable is first described below.

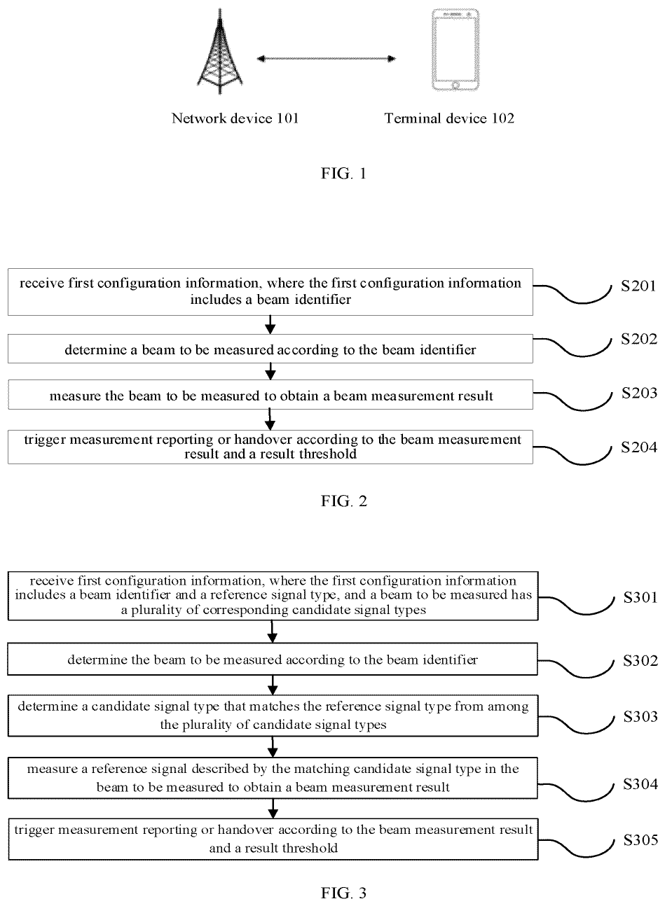

Please refer to FIG. 1, which is a schematic diagram of an architecture of a communication system provided by an embodiment of the present disclosure. The communication system may include, but is not limited to, a network device and a terminal device. The number and form of devices shown in FIG. 1 are only used as examples and do not constitute a limitation on the embodiments of the present disclosure. In actual applications, two or more network devices and two or more terminal devices may be included. The communication system shown in FIG. 1 includes, for example, a network device 101 and a terminal device 102.

It should be noted that the technical solutions of the embodiments of the present disclosure can be applied to various communication systems, such as a long term evolution (LTE) system, a fifth generation (5G) mobile communication system, a 5G new radio (NR) system, or other future new mobile communication systems.

The network device 101 in the embodiment of the present disclosure is an entity on the network side for transmitting or receiving signals. For example, the network device 101 can be an evolved NodeB (eNB), a transmission reception point (TRP), a next generation NodeB (gNB) in an NR system, a base station in other future mobile communication systems, or an access node in a wireless fidelity (Wi-Fi) system. The embodiments of the present disclosure do not limit the specific technology and specific device form adopted by the network device.

The network device provided by the embodiments of the present disclosure may be composed of a centralized unit (CU) and distributed units (DUs), where the CU may also be referred to as a control unit. The CU-DU structure may be used to separate protocol layers of a network device, such as a base station, with functions of some protocol layers being placed in the CU and being centrally controlled, and functions of the remaining part or all of the protocol layers being distributed in the DUs and the DUs being centrally controlled by the CU.

The terminal device 102 in the embodiment of the present disclosure is an entity on the user side for receiving or transmitting signals, such as a mobile phone. The terminal device may also be referred to as a terminal, user equipment (UE), a mobile station (MS), a mobile terminal (MT), etc. The terminal device may be a automobile with communication function, a smart automobile, a mobile phone, a wearable device, a tablet (Pad), a computer with wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc.

The embodiments of the present disclosure do not limit the specific technology and specific device form adopted by the terminal device.

In the mobility management process of the communication system, the terminal device 102 can perform corresponding measurement operations according to the configuration information sent by the network device 101, and determine whether to trigger measurement reporting or handover according to the measurement results. The terminal device mentioned in the embodiments of the present disclosure may refer to the terminal device 102, and the network device may refer to the network device 101.

It can be understood that the communication system described in the embodiments of the present disclosure is for the purpose of more clearly illustrating the technical solutions of the embodiments of the present disclosure, and does not constitute a limitation on the technical solutions provided by the embodiments of the present disclosure. A person skilled in the art can understand that with the evolution of the system architecture and the emergence of new business scenarios, the technical solutions provided by the embodiments of the present disclosure are also applicable to similar technical problems.

The mobility management method and apparatus for the same provided by the present disclosure are described in detail below in conjunction with the accompanying drawings. FIG. 2 is a flow chart of a mobility management method provided by an embodiment of the present disclosure, which is executed by a terminal device. The mobility management method in this embodiment can be applied in a terminal device, such as a mobile phone or a tablet with mobile communication function, a smart watch, etc., which is not limited here.

As shown in FIG. 2, the method may include but is not limited to the following steps,

In step S201, first configuration information is received, where the first configuration Information includes a beam identifier.

The configuration information may refer to relevant information pre-configured by a network device based on communication network environment accessed by the terminal device.

The first configuration information can be used to perform measurement reporting or handover control on the terminal device. The first configuration information can be used to describe information related to a measurement object. The first configuration information carries a beam identifier, the beam identifier can be configured by the network device to form the first configuration information, and the first configuration information is then sent by the network device to the terminal device to be adopted by the terminal device to determine the beam that is to be measured (the beam that is to be measured can be referred to as the beam to be measured) so as to subsequently evaluate whether a relevant event for the measurement reporting or handover is met.

It can be understood that in the communication network environment that is accessed by the terminal device, there may be multiple beams (including a beam that is currently used by the terminal device and beams that are currently not used by the terminal device), and qualities of multiple channels corresponding to the multiple beams may be different.

The beam identifier can be an identifier of a time-frequency resource set or a sequence, points to a list of resource sets configured by the network, and can be data used to characterize beam relevant information. The beam identifier can be used to identify the beam to assist in identifying the beam to be measured from multiple beams in the communication network environment accessed by the terminal device, and the channel information of the corresponding beam can also be determined based on the beam identifier, which is not limited here.

In the embodiment of the present disclosure, the network device may also use the beam identifier and any other possible information content, such as quantity configuration information or reporting configuration information, as the first configuration information, and send it to the terminal device, and the terminal device performs corresponding processing based on the first configuration information, which is not limited here, In the embodiment of the present disclosure, the quantity of the above first configuration information may be one or more, that is, the network device may configure multiple pieces of first configuration information, so that different pieces of first configuration information may carry different beam identifiers. After receiving the multiple pieces of first configuration information, the terminal device may perform reporting using the adapted beam measurement result reporting event based on the beam identifier carried in each piece of first configuration information. For details, please refer to the subsequent embodiments.

In step S202, a beam to be measured is determined according to the beam identifier.

The beam to be measured refers to a beam that is to be measured. The beam to be measured may be determined based on the above beam identifier, and the number of the beams to be measured may be one or more.

In some embodiments, when determining the beam to be measured according to the beam identifier, a beam set that meets the beam identifier can be determined based on the beam identifier, and then multiple beams in the beam set can be directly used as the beams to be measured; or multiple beams that meet the beam identifier can be determined based on the beam identifier, and then some beams are randomly selected from the multiple beams as the beams to be measured; of course, any other possible method can be used in combination with the beam identifier to determine the beam to be measured, such as pre-configuring priority information of the multiple beams, or determining the beam to be measured in response to user configuration instructions, which is not limited here.

In the embodiment of the present disclosure, the beam to be measured is determined according to the beam identifier, and the beam to be measured can be used as a measurement object, thereby providing a measurement object that can be referenced in the measurement process of the terminal device.

In step S203, measurement is performed on the beam to be measured to obtain a beam measurement result.

The beam measurement result may refer to a result obtained based on the measurement on the beam to be measured, and the beam measurement result may be used to trigger measurement reporting or handover. For example, if a specified type of signal on the beam to be measured is measured, the beam measurement result may be, for example, a signal quality, signal strength, or other results of the specified type of signal, if a channel corresponding to the specified type of signal on the beam to be measured is measured, the beam measurement result may be a channel quality or other results, which is not limited here.

In the embodiment of the present disclosure, when performing measurement on the beam to be measured to obtain the beam measurement result, the measurement can be performed on the beam to be measured to obtain multiple measurement results of different measurement types, and a weighting process can be performed on the obtained multiple measurement results to obtain the beam measurement result, or the multiple measurement results can be analyzed and compared to determine the optimal measurement result as the beam measurement result, which is not limited here.

In the embodiment of the present disclosure, by measuring the beam to be measured, the obtained beam measurement result can effectively characterize the communication service quality of the corresponding beam to be measured, thereby providing an accurate trigger reference basis for subsequently triggering the measurement reporting or handover.

In step S204, measurement reporting or handover is triggered according to the beam measurement result and a result threshold.

The result threshold refers to a threshold for the beam measurement result that is used to trigger the measurement reporting or handover. The result threshold can be determined and indicated by the network device, that is, the network device can determine and indicate the result threshold for the beam measurement result corresponding to the beam identifier, and send the result threshold to the terminal device to indicate the terminal device to trigger the measurement reporting or handover based on the result threshold and the beam measurement result.

An embodiment of the present disclosure provides a mobility management method, where the result threshold is determined from second configuration information corresponding to the first configuration information. In some embodiments, the result threshold may also be determined by the terminal device based on its own network environment, or may be configured in response to user configuration instructions, which is not limited here.

In the embodiment of the present disclosure, the terminal device receives the second configuration information before receiving the first configuration information or after receiving the first configuration information, or the terminal device receives the second configuration information at the same time as receiving the first configuration information, which is not limited here.

For example, the terminal device can receive a message sent by a network device, and parse the message to obtain the first configuration information and/or the second configuration information, that is, parsing the first configuration information and the second configuration information simultaneously from the message can be supported, or the first configuration information or the second configuration information can be separately parsed from the message, or parsing the first configuration information based on one message and parsing the second configuration information based on another message can also be supported, and there is no restriction on the transmission order of different messages, that is, they can be transmitted simultaneously or separately.

The network device can encapsulate the result threshold and carry the result threshold in the second configuration information, and send the result threshold to the terminal device via the second configuration information. After the terminal device obtains the second configuration information, it can parse the second configuration information to obtain the result threshold, so as to determine whether the target result event occurs using the combination of the beam measurement result and the result threshold.

In some embodiments, the network device may send the second configuration information to the terminal device in advance, and the terminal device may save the second configuration information in advance. After receiving the first configuration information sent by the network device and parsing the beam identifier, the terminal device may obtain the second configuration information that matches the first configuration information, and determine the result threshold corresponding to the beam identifier from the second configuration information. For the method for matching correspondence between the first configuration information and the second configuration information, reference can be made to subsequent embodiments for details.

The measurement reporting refers to an operation of reporting the beam measurement result by the terminal device to the network device.

The handover may refer to an operation of performing cell handover or beam handover by the terminal device.

In some embodiments, when triggering the measurement reporting or handover based on the beam measurement result and the result threshold, the beam measurement result and the result threshold can be analyzed and compared, and when the beam measurement result is greater than the result threshold, the measurement reporting or handover is triggered. Alternatively, any other possible method can be used to trigger the measurement reporting or handover based on the beam measurement result and the result threshold, such as a model method, which is not limited here.

That is, the embodiment of the present disclosure supports determining the second configuration information corresponding to the first configuration information, and supports parsing the beam identifier in the first configuration information and parsing the result threshold in the second configuration information. When the beam measurement result of the beam to be measured based on the beam identifier in the first configuration information meets the requirement of the result threshold carried in the second configuration information, the measurement report or handover can be triggered.

In the embodiment of the present disclosure, when the measurement reporting or handover is triggered based on the beam measurement result and the result threshold, there is no need to filter the beam measurement result through layer 3, thereby avoiding affecting the timeliness of the measurement reporting or handover, effectively improving the timeliness of measurement reporting or handover of the terminal device, and effectively improving the communication stability of the terminal device.

In the embodiment, the terminal device receives the first configuration information sent by the network device, the first configuration information including a beam identifier, the terminal device determines, based on the beam identifier, the beam to be measured, performs measurement on the beam to be measured to obtain the beam measurement result, and triggers the measurement reporting or handover based on the beam measurement result and the result threshold. When the measurement reporting or handover is triggered based on the beam measurement result and the result threshold, since there is no need to filter the beam measurement result through layer 3, the delay of the measurement reporting or handover can be effectively reduced, the accuracy of determining the timing of the measurement reporting or handover can be effectively guaranteed, and the timeliness of the measurement reporting or handover can be effectively improved.

FIG. 3 is a flow chart of another mobility management method provided by an embodiment of the present disclosure. The mobility management method in this embodiment can be applied in a terminal device. As shown in FIG. 3, the method may include but is not limited to the following steps.

In step S301, first configuration information is received, where the first configuration information includes a beam identifier and a reference signal type, and the beam to be measured has a plurality of corresponding candidate signal types.

The reference signal refers to a known signal transmitted from the transmitter to the receiver that is used for channel estimation or channel detection, and the reference signal type can be used to describe a signal type of the reference signal. The reference signal type can be, for example, a Single Side Band (SSB), and/or a Channel State Information-Reference Signal (CSI-RS), which is not limited here.

That is, the network device can indicate the beam identifier along with the reference signal type, so that the terminal device can determine the beam to be measured based on the beam identifier. It can be understood that the beam to be measured may correspond to multiple reference signals (the reference signals supported on the beam to be measured can be referred to as candidate reference signals, each of the candidate reference signals corresponds to a signal type, and the signal type corresponding to the candidate reference signal can be referred to as a candidate signal type), and the terminal device can also select, based on the reference signal type indicated by the network device, some signals from the multiple candidate reference signals supported on the beam to be measured for measurement, for which reference can be made to subsequent embodiments for details.

In step S302, the beam to be measured is determined according to the beam identifier.

For detailed description of step S301 and step S302, reference can be made to the description of the above embodiment, which will not be repeated in this embodiment of the present disclosure.

In step S303, a candidate signal type that matches the reference signal type is determined from among the plurality of candidate signal types.

The candidate signals refer to the signals supported on the beam to be measured, and the candidate signal types may refer to the signal types corresponding to the candidate signals. The candidate signal type may be, for example, a Single Side Band (SSB), and/or a Channel State Information-Reference Signal (CSI-RS), which is not limited here.

In the embodiment of the present disclosure, a candidate signal type that matches the reference signal type can be determined from the plurality of candidate signal types, and measurement can be performed on a reference signal that matches the reference signal type on a beam to be measured based on the reference signal type indicated by a network device, thereby facilitating effective execution of the measurement reporting or handover, and facilitating adaptation of the beam measurement result obtained from the measurement based on the determined reference signal to the result threshold indicated by the network device, and ensuring the timeliness and accuracy of the measurement reporting or handover.

In step S304, measurement is performed on a reference signal described by the matching candidate signal type in the beam to be measured to obtain a beam measurement result.

In some embodiments, when determining the beam measurement result, the reference signals described by the matching candidate signal type can be measured to obtain multiple measurement results, and the multiple measurement results can be integrated to obtain the beam measurement result. Alternatively, measurement result comparison information between the reference signals can be determined, and the measurement result comparison information can be used as the beam measurement result, which is not limited here.

In step S305, measurement reporting or handover is triggered according to the beam measurement result and the result threshold.

For detailed description of step S305, reference can be made to the description of the above embodiment, which will not be repeated in this embodiment of the present disclosure.

In this embodiment, based on the reference signal type indicated by the network device, the reference signal matching the reference signal type on the beam to be measured is measured, which can facilitate effective execution of the measurement reporting or handover, and facilitate the adaptation of the beam measurement result obtained from the measurement based on the determined reference signal to the result threshold indicated by the network device, thereby ensuring the timeliness and accuracy of the measurement reporting or handover.

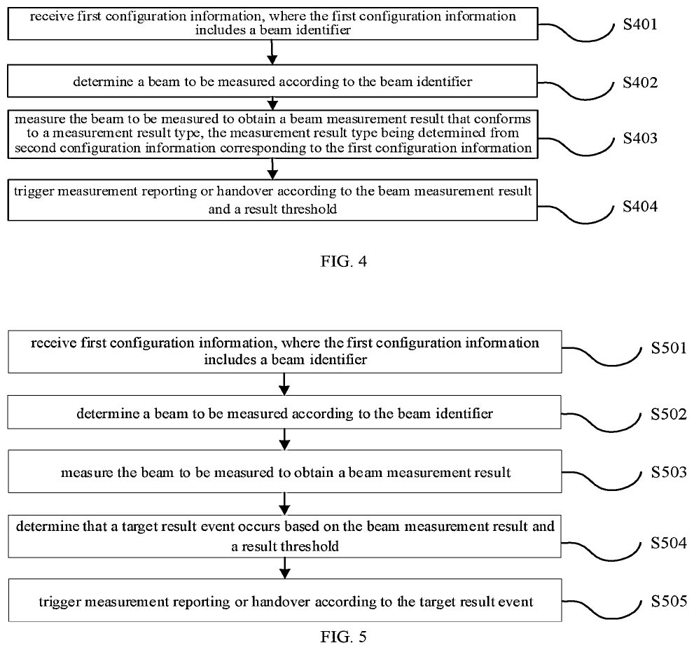

FIG. 4 is a flow chart of another mobility management method provided by an embodiment of the present disclosure. The mobility management method in this embodiment can be applied in a terminal device. As shown in FIG. 4, the method may include but is not limited to the following steps.

In step S401, first configuration information is received, where the first configuration information includes a beam identifier.

In step S402, a beam to be measured is determined according to the beam identifier.

For detailed description of step S401 and step S402, reference can be made to the description of the above embodiment, which will not be repeated in this embodiment of the present disclosure.

In step S403, measurement is performed on the beam to be measured to obtain a beam measurement result that conforms to a measurement result type, where the measurement result type is determined from second configuration information corresponding to the first configuration information.

That is, the network device can also indicate the measurement result type to the terminal device, carry the measurement result type in the second configuration information, and send the measurement result type to the terminal device via the second configuration information. After the terminal device obtains the second configuration information, it can parse the second configuration information to obtain the measurement result type, so as to perform measurement and obtain the beam measurement result that conforms to the measurement result type.

The measurement result type may refer to a type corresponding to the measurement result obtained by measuring the reference signal, such as Reference Signal Received Power (RSRP), Reference Signal Received Quality (RSRQ), Signal to Interference Noise Ratio (SINR), or the like, which is not limited here.

That is, in the embodiment of the present disclosure, the second configuration information may also include the measurement result type, and determining the beam measurement result may be to perform measurement on the beam to be measured based on the measurement result type indicated by the network device to obtain a beam measurement result that conforms to the measurement result type. When the beam to be measured is measured based on the measurement result type indicated by the network device, the adaptability between the obtained measurement result value and the related event that triggers the measurement reporting or handover can be effectively improved, which facilitates the timely and effective detection of the related event that triggers the measurement reporting or handover.

In step S404, measurement reporting or handover is triggered according to the beam measurement result and a result threshold.

For detailed description of step S404, reference can be made to the description of the above embodiment, which will not be repeated in this embodiment of the present disclosure.

In this embodiment, the beam to be measured can be measured based on the measurement result type indicated by the network device to obtain a beam measurement result that conforms to the measurement result type. When the terminal device measures the beam to be measured based on the measurement result type indicated by the network device, the adaptability between the obtained measurement result value and the relevant event that triggers the measurement reporting or handover can be effectively improved, thereby facilitating the timely and effective detection of the relevant event that triggers the measurement reporting or handover.

FIG. 5 is a flow chart of another mobility management method provided in an embodiment of the present disclosure. The mobility management method in this embodiment can be applied in a terminal device. As shown in FIG. 5, the method may include but is not limited to the following steps.

In step S501, first configuration information is received, where the first configuration information includes a beam identifier.

In step S502, a beam to be measured is determined according to the beam identifier.

In step S503, measurement is performed on the beam to be measured to obtain a beam measurement result.

For the detailed description of steps S501 to S503, reference can be made to the description of the above embodiment, which will not be repeated in this embodiment of the present disclosure.

In step S504, it is determined based on the beam measurement result and a result threshold that a target result event occurs.

The target result event may refer to that the beam measurement result meets the result threshold, and the target result event may be used as a trigger condition for the measurement reporting or handover. The beam measurement result meeting the result threshold may refer to that the beam measurement result meets the result threshold in any possible form, which is not limited here.

In step S505, measurement reporting or handover is triggered according to the target result event.

That is to say, in the embodiment of the present disclosure, reporting based on a beam event is indicated, when the beam measurement result meets the result threshold, it is determined that a target result event has occurred, and measurement reporting or handover is triggered in a timely manner, thereby accurately determining the timing of the measurement reporting or handover based on the beam event, thereby ensuring the timeliness of the measurement reporting or handover.

In this embodiment, the occurrence of the target result event can be determined based on the beam measurement result and the result threshold, and then the measurement reporting or handover can be triggered based on the target result event, achieving timely triggering of the measurement reporting or handover, thereby accurately determining the timing of the measurement reporting or handover based on the beam event and ensuring the timeliness of the measurement reporting or handover.

An embodiment of the present disclosure proposes a mobility management method, where the beam to be measured includes a service beam and a reference beam, and correspondingly, the beam measurement result includes a service measurement result value of the service beam and a reference measurement result value of the reference beam. Thus, the service measurement result value and the reference measurement result value can accurately reflect the communication performance information of the service bean and the reference beam in the network environment accessed by the terminal device, thereby providing an effective reference basis for determining the occurrence of the target result event.

The service beam refers to a beam in the beams to be measured that currently provides communication services to the terminal device.

The reference beam refers to a beam selected from the beams to be measured and used as a reference for the measurement result. The reference beam can be used for analysis and comparison of the measurement results between the reference beam and the service beam so as to determine whether to trigger the measurement reporting or handover.

The service measurement result value refers to the measurement result value corresponding to the service beam in the beam measurement result.

The reference measurement result value refers to the measurement result value corresponding to the reference beam in the beam measurement result.

An embodiment of the present disclosure proposes a mobility management method, in which the target result event may be that the service measurement result value is less than or equal to a first threshold, and the reference measurement result value is greater than or equal to a second threshold, where the first threshold and the second threshold are used as result thresholds.

An embodiment of the present disclosure proposes a mobility management method, in which the target result event may be that the reference measurement result value is greater than a sum of the service measurement result value and a third threshold, where the third threshold is used as the result threshold.

An embodiment of the present disclosure proposes a mobility management method, in which the target result event may be that the service measurement result value is less than a fourth threshold, where the fourth threshold is used as the result threshold, thereby avoiding the resource waste caused by triggering the measurement reporting when the reference measurement result value is slightly higher than the service measurement result value, allowing the network device to flexibly indicate the adapted result threshold in different communication network environments, effectively improving the flexibility of the result threshold configuration and adapting to a variety of communication network scenarios.

In the embodiment of the present disclosure, the first threshold, the second threshold, the third threshold, and the fourth threshold may refer to thresholds pre-configured for the service measurement result value or the reference measurement result value.

An embodiment of the present disclosure proposes a mobility management method, in which the above target result event may also be any other possible event, such as a decreasing trend in the service measurement result value or an increasing trend in the reference measurement result value, which is not limited here.

An embodiment of the present disclosure proposes a mobility management method, in which the number of the service beams can be multiple, and accordingly, the multiple service beams correspond to multiple service measurement values respectively.

An embodiment of the present disclosure proposes a mobility management method, in which the service measurement result value may be the maximum service measurement value among multiple service measurement values, or the service measurement result value may also be an average service measurement value of multiple service measurement values, accordingly, the obtained service measurement result value may accurately reflect the service quality upper limit or average service quality of the current service beam, which facilitates the evaluation of the service quality of the service beam. The service measurement value refers to the measurement value obtained by measuring the service beam. The maximum service measurement value refers to the service measurement value with the largest value among multiple service measurement values. The average service measurement value refers to an average value of multiple service measurement values.

An embodiment of the present disclosure proposes a mobility management method, in which the number of the reference beams is multiple, and accordingly, the multiple reference beams correspond to multiple reference measurement values respectively.

An embodiment of the present disclosure proposes a mobility management method, in which the reference measurement result value is the maximum reference measurement value among multiple reference measurement values, or the reference measurement result value is the average reference measurement value of multiple reference measurement values, accordingly, the reference measurement result value can accurately reflect the service quality upper limit or average service quality of the reference beam, which facilitates subsequent analysis and comparison with the service measurement result value, and timely triggering the measurement reporting or handover. The reference measurement value refers to the measurement value obtained by measuring the reference beam. The maximum reference measurement value refers to the reference measurement value with the largest value among multiple reference measurement values. The average reference measurement value refers to an average value of multiple reference measurement values.

That is to say, in the embodiment of the present disclosure, after obtaining the beam measurement result, the occurrence of the target result event can be determined based on the beam measurement result and the result threshold, and then the measurement reporting or handover is triggered based on the target result event. Thus, it can be determined whether the target result event occurs based on the beam measurement result and the result threshold, thereby providing a reliable measurement basis for triggering the measurement reporting or handover.

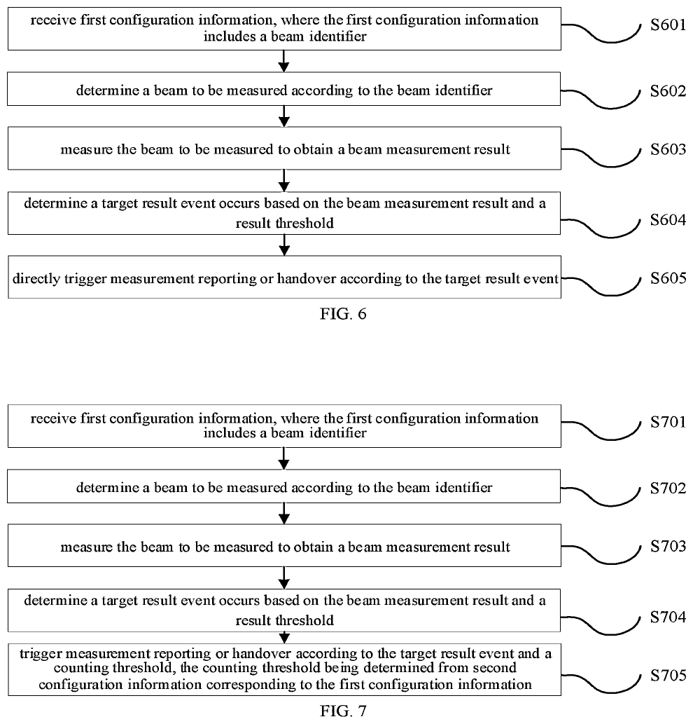

FIG. 6 is a flow chart of another mobility management method provided in an embodiment of the present disclosure. The mobility management method in this embodiment can be applied in a terminal device. As shown in FIG. 6, the method may include but is not limited to the following steps.

In step S601, first configuration information is received, where the first configuration information includes a beam identifier.

In step S602, a beam to be measured is determined according to the beam identifier.

In step S603, measurement is performed on the beam to be measured to obtain a beam measurement result.

In step S604, it is determined based on the beam measurement result and a result threshold that a target result event occurs.

For detailed description of steps S601 to S604, reference can be made to the description of the above embodiment, which will not be repeated in this embodiment of the present disclosure.

In step S605, measurement reporting or handover is directly triggered according to the target result event.

The direct triggering refers to triggering the terminal device to perform measurement reporting or handover upon the above target result event is detected.

It can be understood that in some network environments, there are high requirements for the communication quality of the terminal device, and the target result event may affect the communication quality of the terminal device. When measurement reporting or handover is directly triggered based on target result event, the communication quality of the terminal device can be optimized in a timely manner when the target result event is detected.

In this embodiment, when the measurement reporting or handover is directly triggered according to the target result event, the measurement reporting or handover can be triggered in a timely manner when the target result event occurs, thereby effectively improving the timeliness of triggering the measurement reporting or handover, so that the mobility management method can effectively adapt to communication scenarios with high timeliness requirements.

FIG. 7 is a flow chart of another mobility management method provided in an embodiment of the present disclosure. The mobility management method in this embodiment can be applied in a terminal device. As shown in FIG. 7, the method may include but is not limited to the following steps.

In step S701, first configuration information is received, where the first configuration information includes a beam identifier.

In step S702, a beam to be measured is determined according to the beam identifier.

In step S703, measurement is performed on the beam to be measured to obtain a beam measurement result.

In step S704, it is determined based on the beam measurement result and a result threshold that a target result event occurs.

For the detailed description of steps S701 to S704, reference can be made to the description of the above embodiment, which will not be repeated in this embodiment of the present disclosure.

In step S705, measurement reporting or handover is triggered according to the target result event and a counting threshold, where the counting threshold is determined from second configuration information corresponding to the first configuration information.

The counting threshold refers to a threshold pre-configured for the number of times of occurrence of the target result event, which can be used to be analyzed and compared with the number of times of occurrence of the target result event so as to determine whether to trigger the measurement reporting or handover. The counting threshold can also be determined from the second configuration information corresponding to the first configuration information, that is, it can be indicated by the network device.

An embodiment of the present disclosure proposes a mobility management method, in which when triggering the measurement reporting or handover according to the target result event and the counting threshold, a first number of times of occurrence of the target result event can be determined, In response to the first number of times of occurrence reaching the counting threshold, the measurement reporting or handover is triggered. By determining the first number of times of occurrence and comparing it with the counting threshold, and then triggering the measurement reporting or handover in time when the first number of times of occurrence reaches the counting threshold, it is effectively avoided that the first number of times of occurrence exceeds the counting threshold and affects the communication quality of the terminal device.

The first number of times of occurrence is the number of times obtained by continuously counting the times of occurrence of the target result event.

For example, a counting device (or a counting module) can be configured in advance in the execution entity of the embodiments of the present disclosure, an initial count value of the counting device can be set to 0, and then the counting device is used to count the number of times of occurrence of the target result in the mobility management process, that is, when a complete target result event is detected, the count value in the counting device is increased by 1. In this way, the count value in the counting device can be used as the first number of times of occurrence to represent the number of times of occurrence of the target result event up to the current time point.

In the embodiment of the present disclosure, when the measurement reporting or handover is triggered according to the target result event and the counting threshold, characteristic information of two dimensions, the target result event and the counting threshold, can be effectively used in combination to achieve accurate triggering of the measurement reporting or handover.

In this embodiment, the measurement reporting or handover can be triggered according to the target result event and the counting threshold. The counting threshold is determined from the second configuration information corresponding to the first configuration information. The characteristic information of the two dimensions of the target result event and the counting threshold can be effectively used in combination to achieve accurate triggering of the measurement reporting or handover.

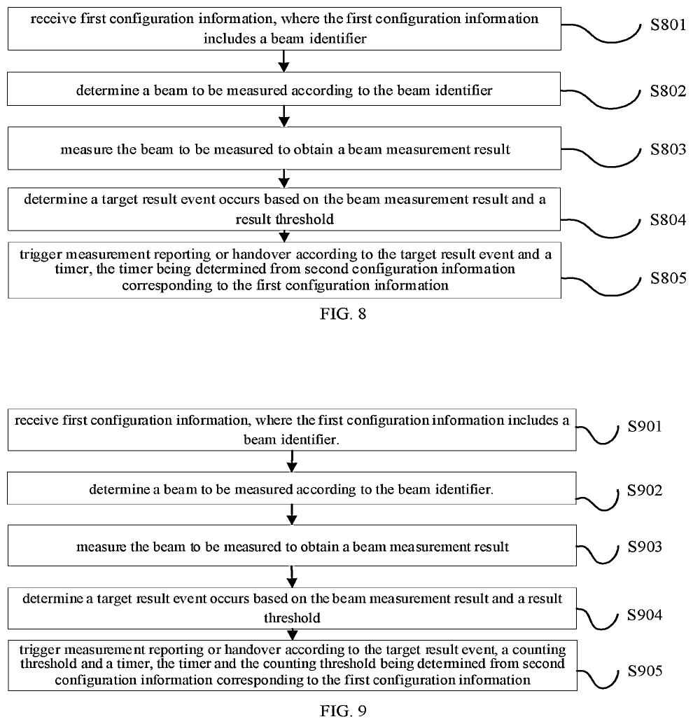

FIG. 8 is a flow chart of another mobility management method provided in an embodiment of the present disclosure. The mobility management method in this embodiment can be applied in a terminal device. As shown in FIG. 8, the method may include but is not limited to the following steps.

In step S801, first configuration information is received, where the first configuration information includes a beam identifier.

In step S802, a beam to be measured is determined according to the beam identifier.

In step S803, measurement is performed on the beam to be measured to obtain a beam measurement result.

In step S804, it is determined based on the beam measurement result and a result threshold that a target result event occurs.

For detailed description of steps S801 to S804, reference can be made to the description of the above embodiment, which will not be repeated in this embodiment of the present disclosure.

In step S805, measurement reporting or handover is triggered according to the target result event and a timer, where the timer is determined from second configuration information corresponding to the first configuration information.

The timer has a corresponding timing period, which can be indicated by the network device and is used to determine the timing time for triggering the measurement reporting or handover.

In the embodiment of the present disclosure, when triggering measurement reporting or handover based on the target result event and the timer, the timing period of the timer can be determined and used as a reference time range for identifying the target result event. If the target result event occurs within the reference time range, the measurement reporting or handover can be directly triggered. Alternatively, if the target result event occurs within the reference time range, and event attribute information or the like meets the requirements, the measurement reporting or handover can be triggered, which is not limited here

The event attribute information can be, for example, a time duration of occurrence of the target result event, or a cumulative number of times of occurrence of the target result event, or pre-configured event priority information corresponding to the target result event, etc., which is not limited here.

The event attribute information or the like meeting the requirements may be, for example, that a duration ratio of the time duration relative to the reference time range is greater than a ratio threshold, or the accumulated number of times of occurrence conforms to a number condition, or the event priority information of the target result event meets a priority condition, which is not limited here.

An embodiment of the present disclosure proposes a mobility management method, in which when triggering the measurement reporting or handover according to the target result event and the timer, the timer may be started, and within the timing period of the timer, in response to the occurrence of the target result event, the measurement reporting or handover is triggered. Since the triggering condition of the measurement reporting and handover may be associated with the time characteristics of the target result event, when the measurement reporting is triggered according to the target result event within the timing period, it can effectively avoid the waste of resources caused by triggering the measurement reporting event in the non-timing time period, thereby effectively improving the resource utilization of the mobility management method. It can be understood that the conditions for triggering measurement reporting or handover may also be different in different time periods. For example, the number of schedulable resources of the communication system during the night and during the day, the service direction of the terminal device, etc., may affect the triggering conditions of the measurement reporting or handover.

In this embodiment, the measurement reporting or handover can be triggered according to the target result event and the timer. The timer is determined from the second configuration information corresponding to the first configuration information. The timer indicated by the network device can be used in combination with the target result event, achieving accurate triggering of the measurement reporting or handover. By starting the timer, and triggering the measurement reporting or handover in response to the occurrence of the target result event within the timing period of the timer, when the measurement reporting is triggered according to the target result event within the timing period, it can effectively avoid the waste of resources caused by triggering the measurement reporting event in the non-timing time period, thereby effectively improving the resource utilization of the mobility management method.

FIG. 9 is a flow chart of another mobility management method provided in an embodiment of the present disclosure. The mobility management method in this embodiment can be applied in a terminal device. As shown in FIG. 9, the method may include but is not limited to the following steps.

In step S901, first configuration information is received, where the first configuration information includes a beam identifier.

In step S902, a beam to be measured is determined according to the beam identifier.

In step S903, measurement is performed on the beam to be measured to obtain a beam measurement result.

In step S904, it is determined based on the beam measurement result and a result threshold that a target result event occurs.

For detailed description of steps S901 to S904, reference can be made to the description of the above embodiment, which will not be repeated in this embodiment of the present disclosure.

In step S905, measurement reporting or handover is triggered according to the target result event, a counting threshold, and a timer, where the timer and the counting threshold are determined from second configuration information corresponding to the first configuration information.

In the embodiment of the present disclosure, the measurement reporting or handover is triggered according to the target result event, the counting threshold, and the timer, the timer can be started and the total elapsed time for the number of times of occurrence of the target result event to reach the counting threshold can be determined, and if the elapsed time is within the timing period of the timer, the measurement reporting or handover is triggered. Alternatively, an average time interval between two adjacent target result events can be determined based on the timer and the counting threshold, and then the measurement reporting or handover is triggered based on the average time interval and the counting threshold, which is not limited here.

For example, the counting threshold can be pre-configured as 10, and the timing period in the timer can be pre-configured as 60 minutes. Timing is performed during the mobility management process, and the number of times of occurrence of the target result event is counted. When the number of times of occurrence of the target result event reaches 10, the timing time at this time is determined to be 45 minutes (that is, the total elapsed time for occurrence of 10 target result events), and then the timing time of 45 minutes is analyzed and compared with the timing period of 60 minutes pre-configured in the timer. The comparison result is that the timing time is less than the timing period, and it is determined that the measurement reporting or handover is triggered at this time.

For example, the counting threshold can be pre-configured to be 10 and the average time interval threshold can be pre-configured to be 10 minutes. During the mobility management process, when the target result event occurs for the first time, the timer is controlled to start timing, and in response to the 10th target result event, the timer is controlled to stop timing to obtain the total elapsed time of the 10 target result events (for example, 60 minutes), and then a division operation is performed based on the total elapsed time and the counting threshold to obtain the average time interval between two adjacent target result events as 6 minutes. Since this average time interval is less than the preset average time interval threshold, it can be determined that measurement reporting or handover is triggered at this time.

In some embodiments, when the measurement reporting or handover is triggered according to the target result event, the counting threshold, and the timer, the timer can be started, a second number of time of occurrence of the target result event is counted within the timing period of the timer, and the measurement reporting or bandover is triggered in response to the second number of time of occurrence reaching the counting threshold. Thus, the characteristics of dimensions of the timing period, the target result event, and the counting threshold can be effectively used in combination to achieve accurate determination of whether to trigger the measurement reporting or handover, which can effectively improve the reliability of triggering the measurement reporting or handover.

The second number of time of occurrence may refer to the number of times of occurrence of the target result event within the timing period.

That is to say, in the embodiments of the present disclosure, after determining that a target result event has occurred based on the beam measurement result and the result threshold, the measurement reporting or handover can be directly triggered based on the target result event, or the measurement reporting or handover can be triggered based on the target result event and the counting threshold, or the measurement reporting or handover can be triggered based on the target result event and the timer, or the measurement reporting or handover can be triggered based on the target result event, the counting threshold, and the timer. Thus, the conditions for triggering the measurement reporting can be flexibly configured based on the counting threshold and/or the timer so that it is applicable to different communication network environments, thereby effectively improving the flexibility of the measurement reporting or handover triggering.

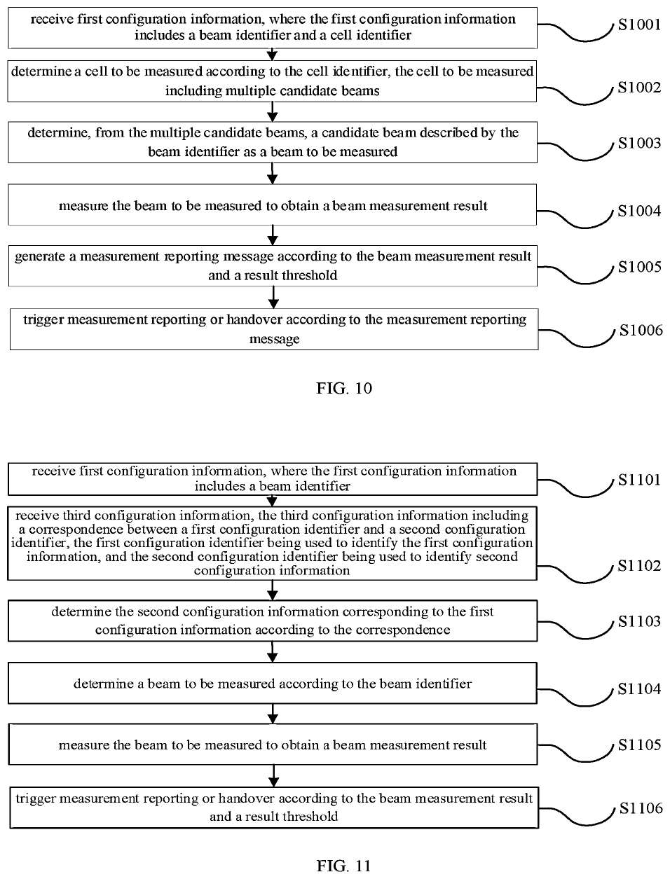

FIG. 10 is a flow chart of another mobility management method provided in an embodiment of the present disclosure. The mobility management method in this embodiment can be applied in a terminal device. As shown in FIG. 10, the method may include but is not limited to the following steps.

In step S1001, first configuration information is received, where the first configuration information includes a beam identifier and a cell identifier.

A cell refers to an area in a communication network that provides wireless communication services to terminal devices. The cell is a basic composition unit of the wireless network. One or more beams can exist in a single cell. The cell identifier can be used to uniquely identify the cell.

That is, the network device may also indicate a cell identifier of a cell to be measured, and write the indicated cell identifier into the first configuration information and send it to the terminal device. After receiving the cell identifier, the terminal device may trigger subsequent. steps.

In step S1002, a cell to be measured is determined according to the cell identifier, where the cell to be measured includes multiple candidate beams.

The cell to be measured may refer to one or more cells determined from the cell identifier(s), and the cell to be measured may include multiple candidate beams. The candidate beams may refer to multiple beams located in the cell(s) to be measured.

In the embodiment of the present disclosure, the cell to be measured is determined according to the cell identifier, which can effectively narrow the screening range of the beam to be measured and effectively avoid the influence of repeated marking of the beam identifiers on the determination of the beam to be measured.

In step S1003, a candidate beam described by a beam identifier is determined from among the multiple candidate beams, as a beam to be measured.

In the embodiment of the present disclosure, a third-party identification device may be used to perform identification on the multiple candidate beams so as to determine the beam to be measured, or the terminal device may perform random selection from the multiple candidate beams and use the selection result as the beam to be measured, which is not limited here.

An embodiment of the present disclosure proposes a mobility management method, in which the beam identifier may include a service beam identifier. When determining the candidate beam described by the beam identifier as the beam to be measured from the multiple candidate beams, the candidate beam described by the service beam identifier can be determined from the multiple candidate beams, as the service beam, and other candidate beams among the multiple candidate beams except the service beam can be used as reference beams. Thus, the service beam can be identified based on the service beam identifier indicated by the network device, and accurate classification of multiple candidate beams in the communication network accessed by the terminal device can be achieved, which facilitates subsequent analysis and comparison of the service beam and the reference beam to determine the timing for triggering the measurement reporting or handover.

The service beam refers to a beam that is currently used by the terminal device in the beams to be measured, the service beam identifier can be used to uniquely identify the service beam, and the service beam identifier may include, for example, location information or number information.

The reference beam refers to a beam that is selected from the beams to be measured and used as reference. The reference beam can be analyzed and compared with the service beam so as to determine whether to trigger the measurement reporting or handover.

That is to say, in the embodiment of the present disclosure, the first configuration information also includes a cell identifier. After receiving the first configuration information, the cell to be measured can be determined based on the cell identifier. The cell to be measured includes multiple candidate beams, and a candidate beam described by the beam identifier is determined from the multiple candidate beams as the beam to be measured. Since the beam identifiers of different cells may overlap, when the cell identifier is introduced to assist in determining the beam to be measured, accurate identification of the beam to be measured can be achieved, thereby effectively improving the accuracy of the obtained beam to be measured.

In step S1004, measurement is performed on the beam to be measured to obtain a beam measurement result.

For a detailed description of step S1004, reference can be made to the description of the above embodiment, which will not be repeated here.

In step S1005, a measurement reporting message is generated according to the beam measurement result and a result threshold.

The measurement reporting message may refer to the relevant information generated by the terminal device based on the beam measurement result and the result threshold, which may be used to trigger the measurement reporting and carry relevant information, and is transmitted by the terminal device to the network device so that the network device can perform corresponding handover control. In the embodiment of the present disclosure, by generating the measurement reporting message based on the beam measurement result and the result threshold, reliable data transmission information can be provided for the subsequent triggering of the measurement reporting, so that the network device can obtain the relevant information of the terminal device.

In step S1006, measurement reporting or handover is triggered according to the measurement reporting message.

In the embodiment of the present disclosure, the measurement reporting message may carry communication status and device information of the terminal device, and so on, which is not limited here.

An embodiment of the present disclosure proposes a mobility management method, in which the measurement reporting message carries any one of the following: the beam identifier; the cell identifier; or a third configuration identifier, where the third configuration identifier is used to identify third configuration information, and the third configuration information. includes a correspondence between a first configuration identifier and a second configuration identifier, the first configuration identifier is used to identify the first configuration information, and the second configuration identifier is used to identify the second configuration information. Thus, the measurement reporting message can be effectively expanded, thereby providing a reliable reference basis for the network device to send control instructions, and the implementation effect of the mobility management method can be effectively improved.

In the embodiments of the present disclosure, the terminal device can receive a message sent by the network device, and parse the message to obtain the first configuration information, and/or the second configuration information, and/or the third configuration information, that is, parsing to obtain the first configuration information, the second configuration information, and the third configuration information simultaneously can be supported; alternatively, the message can be parsed to obtain the first configuration information, the second configuration information, or the third configuration information separately; alternatively, parsing to obtain the first configuration information based on one message, to obtain the second configuration information based on another message, and to obtain the third configuration information based on a third message can be also supported, and there is no restriction on the transmission order of different messages, that is, they can be transmitted simultaneously or separately.

In this embodiment, after obtaining the beam measurement result, the measurement reporting message can be generated based on the beam measurement result and the result threshold, and the measurement reporting or handover can be triggered based on the measurement reporting message. In this way, it can be ensured that the network device can obtain the corresponding event information when the measurement reporting is triggered, thereby effectively improving the mobility management effect.

FIG. 11 is a flow chart of another mobility management method provided in an embodiment of the present disclosure. The mobility management method in this embodiment can be applied in a terminal device. As shown in FIG. 11, the method may include but is not limited to the following steps.

In step S1101, first configuration information is received, where the first configuration information includes a beam identifier.

For detailed description of step S1101, reference can be made to the description of the above embodiment, which will not be repeated here.

In step S1102, third configuration information is received, where the third configuration information includes a correspondence between a first configuration identifier and a second configuration identifier, the first configuration identifier is used to identify the first configuration information, and the second configuration identifier is used to identify second configuration information.

The third configuration message may be relevant information configured by the network device based on the correspondence between the first configuration identifier and the second configuration identifier. It can be understood that in the application scenarios of the embodiments of the present disclosure, the quantity of the first configuration information may be multiple, the quantity of the second configuration information may also be multiple, and there may be a mapping relationship between the first configuration information and the second configuration information. When the third configuration information is received, a reliable reference basis can be provided for the terminal device to determine the second configuration information that matches the first configuration information.

In step S1103, the second configuration information corresponding to the first configuration information is determined according to the correspondence.

In the embodiment of the present disclosure, when the second configuration information corresponding to the first configuration information is determined based on the correspondence, in the case where the terminal device stores multiple pieces of second configuration information in advance, the second configuration information matching the first configuration information can be accurately determined based on the third configuration information, thereby facilitating acquisition of accurate second configuration information without relying on retransmitting the adapted second configuration information by the network device, thereby reducing the consumption of configuration information transmission resources and ensuring the stability of the measurement reporting and handover.

In step S1104, a beam to be measured is determined according to the beam identifier.

In step S1105, measurement is performed on the beam to be measured to obtain a beam measurement result.

In step S1106, measurement reporting or handover is triggered according to the beam measurement result and a result threshold.

For detailed description of steps S1104 to S1106, reference can be made to the description of the above embodiment, which will not be repeated here.

In this embodiment, the third configuration information can be received, and the third configuration information includes a correspondence between a first configuration identifier and a second configuration identifier, the first configuration identifier is used to identify the first configuration information, the second configuration identifier is used to identify the second configuration information, and the second configuration information corresponding to the first configuration information is determined according to the correspondence. Based on the third configuration information, the second configuration information matching the first configuration information can be accurately determined, so that accurate second configuration information can be obtained without relying on retransmitting the adapted second configuration information by the network device, thereby reducing the consumption of configuration information transmission resources and ensuring the stability of the measurement reporting and handover.

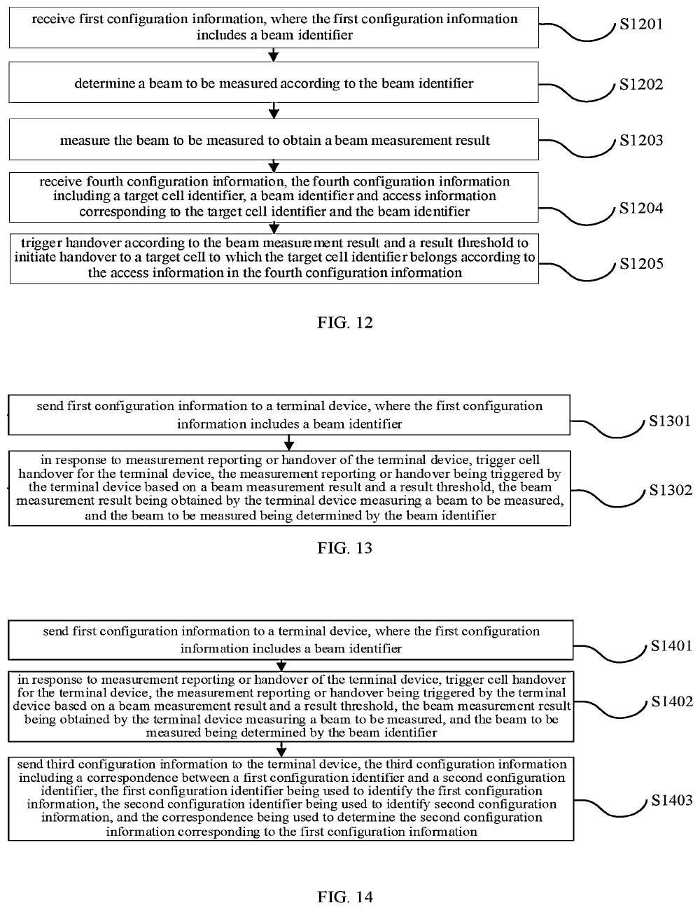

FIG. 12 is a flow chart of another mobility management method provided in an embodiment of the present disclosure. The mobility management method in this embodiment can be applied in a terminal device. As shown in FIG. 12, the method may include but is not limited to the following steps.

In step S1201, first configuration information is received, where the first configuration information includes a beam identifier.

In step S1202, a beam to be measured is determined according to the beam identifier.

In step S1203, measurement is performed on the beam to be measured to obtain a beam measurement result.

For detailed description of steps S1201 to S1203, reference can be made to the description of the above embodiment, which will not be repeated in this embodiment of the present disclosure.

In step S1204, fourth configuration information is received, where the fourth configuration information includes a target cell identifier, a beam identifier, and access information corresponding to the target cell identifier and the beam identifier.

The access information may refer to a time-frequency resource set, a measurement result type, transmission power, a codebook, a random access resources, etc. that corresponds to the beam, which is not limited here.

In this embodiment, by receiving the fourth configuration information, accurate access information can be provided for the subsequent handover process, ensuring the stability of the cell handover of the terminal device.

In step S1205, handover is triggered according to the beam measurement result and a result threshold to initiate handover to a target cell to which the target cell identifier belongs according to the access information in the fourth configuration information.

The target cell refers to the cell indicated by the target cell identifier.

In the embodiment of the present disclosure, the communication service quality of the target cell may be higher than the communication service quality of the cell where the terminal device is currently located, and initiating handover to the target cell can effectively improve the communication quality of the terminal device.

That is to say, in the embodiment of the present disclosure, the fourth configuration information can be received, where the fourth configuration information includes: a cell identifier, a beam identifier, and access information corresponding to the cell identifier and the beam identifier, and when the handover is triggered, the handover to the target cell to which the cell identifier belongs is initiated according to the access information in the fourth configuration information. Thus, the terminal device can determine the access information in advance, thereby achieving fast handover when the handover is triggered, effectively avoiding the delay caused by the information exchange when the handover is triggered, and greatly improving the execution efficiency of the cell handover.

In this embodiment, the fourth configuration information can be received, where the fourth configuration information includes a cell identifier, a beam identifier, and access information corresponding to the cell identifier and the beam identifier, and when the handover is triggered, the handover to the target cell to which the cell identifier belongs is initiated according to the access information in the fourth configuration information. In this way, the terminal device can predetermine the access information, thereby achieving fast handover when the handover is triggered, effectively avoiding the delay caused by the information exchange when the handover is triggered, and greatly improving the execution efficiency of the cell handover,

FIG. 13 is a flow chart of another mobility management method provided in an embodiment of the present disclosure. The mobility management method in this embodiment can be applied in a network device. As shown in FIG. 13, the method may include but is not limited to the following steps.

In step S1301, first configuration information is sent to a terminal device, where the first configuration information includes a beam identifier.

In the embodiment of the present disclosure, by sending the first configuration information to the terminal device, relevant configuration information can be provided for measurement reporting or handover of the terminal device, so that the terminal device can determine a beam to be measured from multiple beams based on the beam identifier, and then trigger measurement reporting or handover based on the beam measurement result.

In step S1302, in response to measurement reporting or handover by the terminal device, a cell handover for the terminal device is triggered, where the measurement reporting or handover is triggered by the terminal device based on a beam measurement result and a result threshold, the beam measurement result is obtained by the terminal device performing measurement on the beam to be measured, and the beam to be measured is determined from the beam identifier.

In the embodiment of the present disclosure, the network device triggers the cell handover for the terminal device in response to the measurement reporting or handover of the terminal device, thereby achieving timely control of the terminal device and ensuring the stability of the terminal's working performance.

An embodiment of the present disclosure proposes a mobility management method, in which the result threshold is determined from second configuration information corresponding to the first configuration information. Thus, the network device side can accurately control the triggering conditions for the measurement reporting or handover of the terminal device based on the second configuration information.

An embodiment of the present disclosure proposes a mobility management method, in which the first configuration information further includes a reference signal type, where the beam to be measured has a plurality of corresponding candidate signal types; and the beam measurement result is obtained by the terminal device performing measurement on a reference signal described by a candidate signal type that matches the reference signal type in the beam to be measured. Thus, the reference type can provide a reliable reference basis for determining a measurement object in the terminal device, thereby effectively improving the pertinence of the measurement process in the terminal device.

An embodiment of the present disclosure proposes a mobility management method, in which the second configuration information further includes a measurement result type, and the measurement reporting or handover is triggered by a beam measurement result that is obtained by performing measurement on the beam to be measured by the terminal device and that conforms to the measurement result type. Accordingly, the network device can indicate the measurement result type that triggers the measurement reporting or handover in the terminal device based on the second configuration information, so that the network device can indicate the adapted measurement result type according to different communication network scenarios.

An embodiment of the present disclosure proposes a mobility management method, in which the measurement reporting or handover is triggered by the terminal device based on a target result event, and the target result event is determined by a beam measurement result and a result threshold, thereby realizing triggering of the measurement reporting or handover based on an event related to the beam measurement result, and effectively improving the timeliness of the measurement reporting or handover.

An embodiment of the present disclosure proposes a mobility management method, in which the second configuration information further includes a counting threshold and/or a timer; where the measurement reporting or handover is triggered by any one of the following: triggered by the terminal device based on a target result event and the counting threshold; or triggered by the terminal device based on the target result event and the timer; or triggered by the terminal device based on the target result event, the counting threshold, and the timer, thereby providing a variety of trigger conditions for performing the measurement reporting in the terminal device, which is applicable to different application scenarios, and facilitates the terminal device to timely trigger the measurement reporting or handover in different application scenarios.

In this embodiment, the first configuration information can be sent to the terminal device, where the first configuration information includes the beam identifier, and in response to measurement reporting or handover of the terminal device, cell handover for the terminal device is triggered, where the measurement reporting or handover is triggered by the terminal device based on a beam measurement result and a result threshold, the beam measurement result is obtained by the terminal device performing measurement on a beam to be measured, the beam to be measured is determined by the beam identifier, and the result threshold is determined from the second configuration information corresponding to the first configuration information. By sending the first configuration information to the terminal device, relevant configuration information can be provided for the measurement reporting or handover of the terminal device, so that the terminal device can determine the beam to be measured from multiple beams based on the beam identifier, and then trigger the measurement reporting or handover based on the beam measurement result, and the cell handover for the terminal device is promptly triggered in response to the measurement reporting of the terminal device, thereby ensuring the stability of the working performance of the terminal device.

FIG. 14 is a flow chart of another mobility management method provided in an embodiment of the present disclosure. The mobility management method in this embodiment can be applied in a network device. As shown in FIG. 14, the method may include but is not limited to the following steps.

In step S1401, first configuration information is sent to a terminal device, where the first configuration information includes a beam identifier.

In step S1402, in response to measurement reporting or handover of the terminal device, cell handover for the terminal device is triggered, where the measurement reporting or handover is triggered by the terminal device based on a beam measurement result and a result threshold, the beam measurement result is obtained by the terminal device performing measurement on a beam to be measured, and the beam to be measured is determined by the beam identifier.

For detailed description of step S1401 and step S1402, reference may be made to the description of the above embodiment, which will not be elaborated here.

In step S1403, third configuration information is sent to the terminal device, where the third configuration information includes a correspondence between a first configuration identifier and a second configuration identifier, the first configuration identifier is used to identify the first configuration information, the second configuration identifier is used to identify second configuration information, and the correspondence is used to determine the second configuration information corresponding to the first configuration information.

It can be understood that in the application scenarios of the embodiments of the present disclosure, the quantity of first configuration information can be multiple, the quantity of second configuration information can also be multiple, and there may be a mapping relationship between the first configuration information and the second configuration information. When the third configuration information is received, it can provide a reliable reference basis for the terminal device to determine the second configuration information that matches the first configuration information.

In this embodiment, the third configuration information can be sent to the terminal device, where the third configuration information includes a correspondence between a first configuration identifier and a second configuration identifier, the first configuration identifier is used to identify the first configuration information, the second configuration identifier is used to identify the second configuration information, and the correspondence is used to determine the second configuration information corresponding to the first configuration information. The third configuration information can be indicated to the terminal device so that the terminal device can accurately determine the second configuration information that matches the first configuration information based on the third configuration information, thereby reducing the consumption of configuration information transmission resources and ensuring the stability of the measurement reporting and handover.

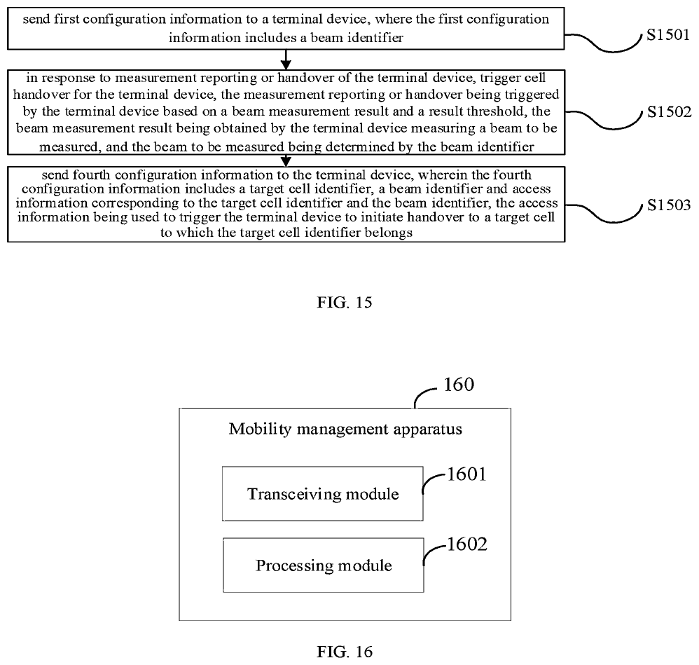

FIG. 15 is a flow chart of another mobility management method provided in an embodiment of the present disclosure. The mobility management method in this embodiment can be applied in a network device. As shown in FIG. 15, the method may include but is not limited to the following steps.

In step S1501, first configuration information is sent to a terminal device, where the first configuration information includes a beam identifier.

In step S1502, in response to measurement reporting or handover of the terminal device, cell handover for the terminal device is triggered, where the measurement reporting or handover is triggered by the terminal device based on a beam measurement result and a result threshold, the beam measurement result is obtained by the terminal device performing measurement on a beam to be measured, and the beam to be measured is determined by the beam identifier.

For detailed description of step S1501 and step S1502, reference can be made to the description of the above embodiment, which will not be repeated in this embodiment of the present disclosure.

In step S1503, fourth configuration information is sent to the terminal device, where the fourth configuration information includes a target cell identifier, a beam identifier, and access information corresponding to the target cell identifier and the beam identifier, and the access information is used to trigger the terminal device to initiate handover to a target cell to which the target cell identifier belongs.

In this embodiment, the fourth configuration information can be sent to the terminal device, where the fourth configuration information includes a target cell identifier, a beam identifier, and access information corresponding to the target cell identifier and the beam identifier, and the access information is used to trigger the terminal device to initiate handover to the target cell to which the target cell identifier belongs, so that the terminal device can directly initiate handover to the target cell to which the target cell identifier belongs when the bandover is triggered, thereby effectively improving the timeliness of the handover process.

In the above embodiments provided by the present disclosure, the methods provided by the embodiments of the present disclosure are explained from the perspectives of the network device and the terminal device, respectively. In order to implement the functions in the methods provided by the above embodiments of the present disclosure, the network device and the terminal device may include hardware structures and software modules, and the above functions may be implemented in the form of hardware structures, software modules, or hardware structures plus software modules. A certain one of the above functions may be executed in the form of hardware structures, software modules, or hardware structures plus software modules.

FIG. 16 is a structural schematic diagram of a mobility management apparatus provided in an embodiment of the present disclosure. The mobility management apparatus 160 shown in FIG. 16 may include a transceiving module 1601 and a processing module 1602. The transceiving module 1601 may include a transmitting module and/or a receiving module, the transmitting module is configured to implement a transmitting function, the receiving module is configured to implement a receiving function, and the transceiving module 1601 may implement the transmitting function and/or receiving function.

The mobility management apparatus 160 may be a terminal device (such as the first terminal device in the aforementioned method embodiments), or a device in the terminal device, or a device that can be used in conjunction with a terminal device. Alternatively, the mobility management apparatus 160 may be a network device, or a device in the network device, or a device that can be used in conjunction with the network device.

The mobility management apparatus 160, on the terminal device side, includes:
a transceiving module 1601, configured to receive first configuration information, where the first configuration information includes a beam identifier;
a processing module 1602, configured to determine a beam to be measured according to the beam identifier, perform measurement on the beam to be measured to obtain a beam measurement result, and trigger measurement reporting or handover according to the beam measurement result and a result threshold.

In some embodiments, the first configuration information further includes a cell identifier; where the processing module 1602 is further configured to:
determine a cell to be measured according to the cell identifier, where the cell to be measured includes multiple candidate beams;
determine, from the multiple candidate beams, a candidate beam described by the beam identifier as the beam to be measured.

In some embodiments, the first configuration information further includes a reference signal type, and the beam to be measured has a plurality of corresponding candidate signal types.

The processing module 1602 is further configured to:
determine, from the plurality of candidate signal types, a candidate signal type that matches the reference signal type; and
perform measurement on a reference signal described by the matching candidate signal type in the beam to be measured to obtain the beam measurement result.

In some embodiments, the result threshold is determined from second configuration information corresponding to the first configuration information.

In some embodiments, the second configuration information further includes a measurement result type.

The processing module 1602 is further configured to: perform measurement on the beam to be measured to obtain the beam measurement result that conforms to the measurement result type.

In some embodiments, the processing module 1602 is specifically configured to:
determine that a target result event occurs according to the beam measurement result and a result threshold; and
trigger measurement reporting or handover according to the target result event.

In some embodiments, the second configuration information further includes a counting threshold and/or a timer.

The triggering the measurement reporting or handover according to the target result event includes any one of the following:
directly triggering the measurement reporting or handover according to the target result event; triggering the measurement reporting or handover according to the target result event and counting threshold; triggering the measurement reporting or handover according to the target result event and timer; or triggering the measurement reporting or handover according to the target result event, the counting threshold, and the timer.

In some embodiments, the processing module 1602 is further configured to:
determine a first number of times of occurrence of the target result event; and in response to the first number of times of occurrence reaching the counting threshold, trigger the measurement reporting or handover.

In some embodiments, the processing module 1602 is further configured to:
start the timer; and in response to occurrence of the target result event within a timing period of the time, trigger the measurement reporting or handover.

In some embodiments, the processing module 1602 is further configured to:
start the timer; count the second number of times of occurrence of the target result event within the timing period of the timer; and in response to the second number of times of occurrence reaching the counting threshold, trigger the measurement reporting or handover.

In some embodiments, the beam to be measured includes a service beam and a reference beam, and accordingly, the beam measurement result includes a service measurement result value of the service beam and a reference measurement result value of the reference beam.

In some embodiments, the target result event is any of the following:
the service measurement result value is less than or equal to a first threshold, and the reference measurement result value is greater than or equal to a second threshold, where the first threshold and the second threshold are used as the result thresholds;
the reference measurement result value is greater than a sum of the service measurement result value and a third threshold, where the third threshold is used as the result threshold; or
the service measurement result value is less than a fourth threshold, where the fourth threshold is used as the result threshold.

In some embodiments, the number of the service beams is multiple, and accordingly, the multiple service beams correspond to multiple service measurement values respectively, where,
the service measurement result value is the maximum service measurement value among the multiple service measurement values; or
the service measurement result value is an average service measurement value of the multiple service measurement values.

In some embodiments, the number of the reference beams is multiple, and accordingly, the multiple reference beams correspond to multiple reference measurement values respectively, where,
the reference measurement result value is the maximum reference measurement value among the multiple reference measurement values; or
the reference measurement result value is an average reference measurement value of the multiple reference measurement values.

In some embodiments, the beam identifier includes a service beam identifier.

The processing module 1602 is further configured to:
determine, from the plurality of candidate beams, a candidate beam described by the serving beam identifier as the serving beam; and
use other candidate beams except the service beam among the plurality of candidate beams as reference beams.

In some embodiments, the transceiving module 1601 is further configured to:
receive third configuration information, where the third configuration information includes a correspondence between a first configuration identifier and a second configuration identifier, the first configuration identifier is used to identify the first configuration information, and the second configuration identifier is used to identify the second configuration information;

The processing module 1602 is further configured to:
determine, according to the correspondence, the second configuration information corresponding to the first configuration information is determined.

In some embodiments, the processing module 1602 is further configured to:
generate a measurement reporting message according to the beam measurement result and a result threshold; and trigger measurement reporting or handover according to the measurement reporting message.

In some embodiments, the measurement reporting message carries any of the following:
the beam identifier; the cell identifier, and a third configuration identifier, where the third configuration identifier is used to identify third configuration information, the third configuration information includes a correspondence between a first configuration identifier and a second configuration identifier, the first configuration identifier is used to identify the first configuration information, and the second configuration identifier is used to identify the second configuration information.

In some embodiments, the transceiving module 1601 is further configured to;
receive fourth configuration information, where the fourth configuration information includes a target cell identifier, a beam identifier, and access information corresponding to the target cell identifier and the beam identifier.

The processing module 1602 is further configured to:
according to the access information in the fourth configuration information, initiate handover to a target cell to which the target cell identifier belongs.

The mobility management apparatus 160, on the network device side, includes:
a transceiving module 1601, configured to send first configuration information to a terminal device, where the first configuration information includes a beam identifier, and
a processing module 1602, configured to trigger a cell handover for the terminal device in response to measurement reporting or handover of the terminal device,
where the measurement reporting or handover is triggered by the terminal device based on a beam measurement result and a result threshold, the beam measurement result is obtained by the terminal device performing measurement on a beam to be measured, and the beam to be measured is determined by the beam identifier.

In some embodiments, the first configuration information further includes a reference signal type, and the beam to be measured has a plurality of corresponding candidate signal types.

The beam measurement result is obtained by the terminal device performing measurement on a reference signal described by a candidate signal type that matches the reference signal type in the beam to be measured.

In some embodiments, the result threshold is determined by second configuration information corresponding to the first configuration information.

In some embodiments, the second configuration information further includes a measurement result type, and the measurement reporting or handover is triggered by the beam measurement result that is obtained by the terminal device performing measurement on the beam to be measured and that conforms to the measurement result type.

In some embodiments, the measurement reporting or handover is triggered by the terminal device based on a target result event, and the target result event is determined by the beam measurement result and a result threshold.

In some embodiments, the second configuration information further includes a counting threshold and/or a timer; where the measurement reporting or handover is triggered by any one of the following: triggered by the terminal device based on the target result event and the counting threshold; triggered by the terminal device based on the target result event and the timer; or triggered by the terminal device based on the target result event, the counting threshold, and the timer.

In some embodiments, the transceiving module 1601 is further configured to:
send third configuration information to the terminal device, where the third configuration information includes a correspondence between a first configuration identifier and a second configuration identifier, the first configuration identifier is used to identify the first configuration information, the second configuration identifier is used to identify second configuration information, and the correspondence is used to determine the second configuration information corresponding to the first configuration information.

In some embodiments, the transceiving module 1601 is further configured to:
send fourth configuration information to the terminal device, wherein the fourth configuration information includes: a target cell identifier, a beam identifier, and access information corresponding to the target cell identifier and the beam identifier, and the access information is used to trigger the terminal device to initiate handover to a target cell to which the target cell identifier belongs.

The mobility management apparatus provided by the present disclosure receives first configuration information sent by a network device, where the first configuration information includes a beam identifier, and determines a beam to be measured based on the beam identifier, measures the beam to be measured to obtain a beam measurement result, and triggers measurement reporting or handover based on the beam measurement result and a result threshold. When the measurement reporting or handover is triggered based on the beam measurement result and the result threshold, since there is no need to filter the beam measurement result through layer 3, the delay of the measurement reporting or handover can be effectively reduced, the accuracy of determining the timing for the measurement reporting or handover can be effectively guaranteed, and the timeliness of the measurement reporting or handover can be effectively improved.

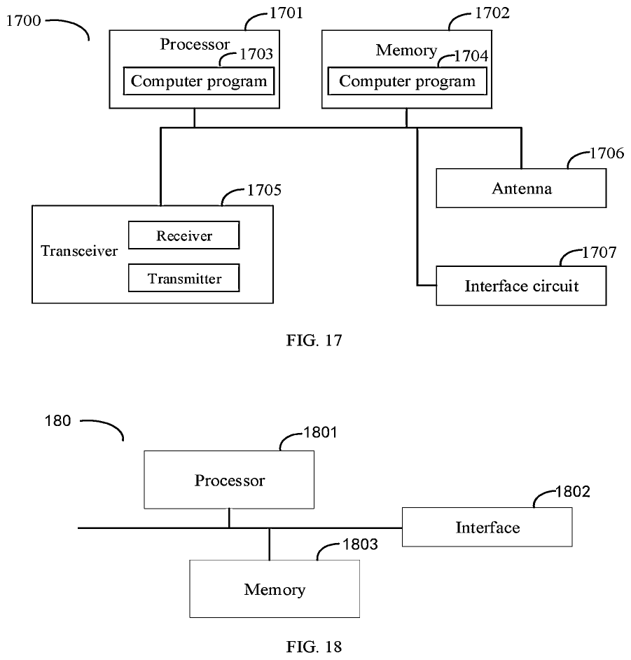

FIG. 17 is a structural schematic diagram of another communication apparatus provided in an embodiment of the present disclosure. The communication apparatus 170 may be a network device, or a terminal device (such as the terminal device in the aforementioned method embodiments), or may be a chip, a chip system, or a processor that supports the network device to implement the aforementioned methods, or may be a chip, a chip system, or a processor that supports the terminal device to implement the aforementioned methods. The apparatus may be configured to implement the methods described in the aforementioned method embodiments, and for the details, reference can be made to the description in the aforementioned method embodiments.

The communication apparatus 170 may include one or more processors 1701, The processor 1701 may be a general-purpose processor, a dedicated processor, or the like, For example, it may be a baseband processor or a central processing unit. The baseband processor may be used to process the communication protocol and communication data, and the central processing unit may be used to control the communication apparatus (such as a base station, a baseband chip, a terminal device, a terminal device chip, a DU, a CU, etc.), execute computer programs, and process data of the computer programs.

In some embodiments, the communication apparatus 170 may further include one or more memories 1702, on which a computer program 1704 may be stored, a computer program 1703 may be stored in the processor 1701, and the processor 1701 executes the computer program 1704 and/or the computer program 1703, to cause the communication apparatus 170 to perform the methods described in the above method embodiments. In some embodiments, data may also be stored in the memory 1702. The communication apparatus 170 and the memory 1702 may be provided separately or integrated together.

In some embodiments, the communication apparatus 170 may further include a transceiver 1705 and an antenna 1706. The transceiver 1705 may be referred to as a transceiving unit, a transceiver, a transceiver circuit, or the like, which is used for implementing a transceiving function. The transceiver 1705 may include a receiver and a transmitter, the receiver may be referred to as a receiver, a receiving circuit, or the like, which is used for implementing a receiving function; the transmitter may be referred to as a transmitter, a transmitting circuit,, or the like, which is used for implementing a transmitting function.

In some embodiments, the communication apparatus 170 may further include one or more interface circuits 1707. The interface circuit 1707 is configured to receive code instructions and transmit them to the processor 1701. The processor 1701 runs the code instructions to cause the communication apparatus 170 to perform the methods described in the above method embodiments.

The communication apparatus 170 is a terminal device (such as the terminal device in the aforementioned method embodiments), the processor 1701 is configured to perform steps S202 to S204 in FIG. 2; steps S302 to S305 in FIG. 3; steps S402 to S404 in FIG. 4; steps S402 to S404 in FIG. 4; steps S502 to S505 in FIG. 5; steps S602 to S605 in FIG. 6; steps S702 to S705 in FIG. 7; steps S802 to S805 in FIG. 8; steps S902 to S905 in FIG. 9; steps S1002 to S1006 in FIG. 10; steps S1103 to S1106 in FIG. 11; or steps S1202, step S1203 and step S1205 in FIG. 12. The transceiver 1705 is configured to perform step S201 in FIG. 2; step S301 in FIG. 3; step S401 in FIG. 4; step S501 in FIG. S; step S601 in FIG, 6; step S701 in FIG. 7; step S801 in FIG. 8; step S901 in FIG. 9; step S1001 in FIG. 10; steps S1101 and S1102 in FIG. 11; or steps S1201 and S1204 in FIG. 12.

The communication apparatus 170 is a network device, the processor 1701 is configured to perform step S1302 in FIG. 13; step S1402 in FIG. 14; or step S1502 in FIG. 15. The transceiver 1705 is configured to perform step S1301 in FIG. 13; perform step S1401 and step S1403 in FIG. 14; or step S1501 and step S1503 in FIG. 15.

In an implementation, the processor 1701 may include a transceiver for implementing the receiving and transmitting functions. For example, the transceiver may be a transceiver circuit, an interface, or an interface circuit. The transceiver circuit, interface, or interface circuit for implementing the receiving and transmitting functions may be separate or may be integrated. The transceiver circuit, interface, or interface circuit may be configured to read and write codes/data, or the transceiver circuit, interface, or interface circuit may be configured to transmit or deliver signals.

In an implementation, the processor 1701 may store a computer program 1703, the computer program 1703 is run on the processor 1701 to cause the communication apparatus 170 to perform the methods described in the above method embodiments. The computer program 1703 may be solidified in the processor 1701, in which case the processor 1701 may be implemented by hardware.

In an implementation, the communication apparatus 170 may include a circuit that can implement the functions of transmitting or receiving or communicating in the aforementioned method embodiments. The processor and transceiver described in the present disclosure may be implemented in an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be manufactured using various IC process technologies, such as complementary metal oxide semiconductor (CMOS), N-type metal oxide semiconductor (nMetal-oxide-semiconductor, NMOS), P-type metal oxide semiconductor (positive channel metal oxide semiconductor, PMOS), bipolar junction transistor (BJT), bipolar CMOS (BiCMOS), silicon germanium (SiGe), gallium arsenide (GaAs), etc.

The communication apparatus described in the above embodiments may be a network device or a terminal device (such as the first terminal device in the aforementioned method embodiments), but the scope of the communication apparatus described in the present disclosure is not limited thereto, and the structure of the communication apparatus may not be limited by FIG. 17. The communication apparatus may be an independent device or may be part of a larger device. For example, the communication apparatus may be:
(1) an independent integrated circuit IC, chip, chip system or subsystem;
(2) a set of one or more ICs, optionally, the set including a storage component for storing data or computer programs;
(3) ASIC, such as a modem;
(4) a module that can be embedded in other devices;
(5) a receiver, terminal device, intelligent terminal device, cellular phone, wireless device, handheld device, mobile unit, vehicle-mounted device, network device, cloud device, artificial intelligence device, etc.; or
(6) Others.

For the case where the communication apparatus can be a chip or a chip system, reference can be made to a structural schematic diagram of a chip shown in FIG. 18. The chip shown in FIG. 18 includes a processor 1801 and an interface 1802. The number of processors 1801 can be one or more, and the number of interfaces 1802 can be multiple.

In the case where the chip is configured to implement the functions of the terminal device in the embodiments of the present disclosure (such as the first terminal device in the aforementioned method embodiments):
the interface 1802 is configured to perform step S201 in FIG. 2; step S301 in FIG. 3; step S401 in FIG. 4; step S501 in FIG. 5; step S601 in FIG. 6; step S701 in FIG. 7; step S801 in FIG. 8; step S901 in FIG. 9; step S1001 in FIG. 10; step S1101 and step S1102 in FIG. 11; or step S1201 and step S1204 in FIG. 12.

In the case where the chip is configured to implement the functions of the network device in the embodiments of the present disclosure:
the interface 1802 is configured to perform step S1301 in FIG. 13; perform step S1401 and step S1403 in FIG. 14; or step S1501 and step S1503 in FIG. 15.

In some embodiments, the chip further includes a memory 1803, and the memory 1803 is configured to store necessary computer programs and data.

Those skilled in the art may also understand that the various illustrative logical blocks and steps listed in the embodiments of the present disclosure may be implemented by electronic hardware, computer software, or a combination of the two. Whether such functions are implemented by hardware or software depends on the specific application and the design requirements of the entire system. Those skilled in the art may employ various methods to implement the described functions for each specific application, but such implementations should not be understood as going beyond the protection scope of the embodiments of the present disclosure.

An embodiment of the present disclosure also provides a communication system, which includes the communication apparatus serving as a terminal device and the communication apparatus serving as a network device in the embodiment of FIG. 17, or the system includes the communication apparatus serving as a terminal device (such as the first terminal device in the aforementioned method embodiments) and the communication apparatus serving as a network device in the embodiment of FIG. 18.

The present disclosure also provides a readable storage medium having stored thereon instructions which, when being executed by a computer, implement the functions of any of the above method embodiments.

The present disclosure also provides a computer program product which, when being executed by a computer, implements the functions of any of the above method embodiments when executed by a computer.

The above embodiments can be implemented entirely or partly by software, hardware, firmware or any combination thereof. When implemented by software, it can be implemented entirely or partly in the form of a computer program product. The computer program product includes one or more computer programs. When the computer program is loaded and executed on a computer, the process or function described in the embodiments of the present disclosure is generated entirely or partly. The computer can be a general-purpose computer, a special-purpose computer, a computer network, or other programmable devices. The computer program can be stored in a computer-readable storage medium, or transmitted from one computer-readable storage medium to another computer-readable storage medium. For example, the computer program can be transmitted from a website site, computer, server or data center to another website site, computer, server or data center by wired (e.g., coaxial cable, optical fiber, digital subscriber line (DSL)) or wireless (e.g., infrared, wireless, microwave, etc.) mode. The computer-readable storage medium can be any available medium that can be accessed by a computer, or a data storage device such as a server or data center that includes one or more available media integrated. The available medium may be a magnetic medium (e.g., a floppy disk, a hard disk, a magnetic tape), an optical medium (e.g., a digital video disc (DVD)), a semiconductor medium (e.g., a solid state disk (SSD)), or the like.

Those skilled in the art can understand that the various numerical numbers such as first and second involved in the present disclosure are only used for the convenience of description and are not intended to limit the scope of the embodiments of the present disclosure, or indicate the sequential order.

In the present disclosure, at least one may also be described as one or more, and a plurality may be two, three, four, or more, which is not limited in the present disclosure. In the embodiments of the present disclosure, technical features for a kind of technical feature are distinguished by “first”, “second”, “third”, “A”, “B”, “C” and “D”, etc., and there is no limitation on the sequential order or size of the technical features described by the “first”, “second”, “third”, “A”, “B”, “C” and “D”.

The corresponding relationships shown in the tables in the present disclosure can be configured or predefined. The values of the information in the tables are only examples and can be configured as other values, which are not limited in the present disclosure, When configuring the corresponding relationship between the information and parameters, it is not necessarily required to configure all the corresponding relationships illustrated in the tables. For example, in the tables in the present disclosure, the corresponding relationships shown in some rows may not be configured. For another example, appropriate variations and adjustments can be made based on the above tables, such as splitting, merging, etc. The names of the parameters shown in the titles of the above tables can also use other names that can be understood by the communication apparatus, and the values or representations of the parameters can also be other values or representations that can be understood by the communication apparatus. When implementing the above tables, other data structures can also be used, such as arrays, queues, containers, stacks, linear lists, pointers, linked lists, trees, graphs, structures, classes, heaps, hash tables or hash tables.

In the present disclosure, “predefined” may be understood as defined, defined in advance, stored, pre-stored, pre-negotiated, pre-configured, solidified, or pre-burned.

Those of ordinary skill in the art will appreciate that the units and algorithm steps of the example described in conjunction with the embodiments disclosed herein can be implemented in electronic hardware, or a combination of computer software and electronic hardware. Whether these functions are performed in hardware or software depends on the specific application and design constraints of the technical solution. Professional technical personnel can use different methods to implement the described functions for each specific application, and such implementations should not be considered as going beyond the scope of the present disclosure.

Those skilled in the art can clearly understand that, for the convenience and brevity of description, for the specific operation processes of the systems, devices and units described above, reference can be made to the corresponding processes in the aforementioned method embodiments, which will not be repeated here.

Those described above are only specific embodiments of the present disclosure, and the protection scope of the present disclosure is not limited thereto. Any person skilled in the art. who is familiar with the technical field can readily think of changes or substitutions within the technical scope disclosed in the present disclosure, which should be covered by the protection scope of the present disclosure. Therefore, the protection scope of the present disclosure should be defined by the protection scope of the claims.

1. A mobility management method, applied to a terminal device, the method comprising:
receiving first configuration information, wherein the first configuration information comprises a beam identifier;
determining a beam to be measured according to the beam identifier;
performing measurement on the beam to be measured to obtain a beam measurement result; and
triggering measurement reporting or handover according to the beam measurement result and a result threshold.

2. The method according to claim 1, wherein the first configuration information further comprises a cell identifier; and the determining the beam to be measured according to the beam identifier comprises:
determining a cell to be measured according to the cell identifier, wherein the cell to be measured comprises a plurality of candidate beams; and
determining, from the plurality of candidate beams, a candidate beam described by the beam identifier as the beam to be measured.

3. The method according to claim 1, wherein the first configuration information further comprises a reference signal type, and the beam to be measured has a plurality of corresponding candidate signal types;
the performing measurement on the beam to be measured to obtain the beam measurement result comprises:
determining, from the plurality of candidate signal types, a candidate signal type matching the reference signal type; and
performing measurement on a reference signal described by the matching candidate signal type in the beam to be measured to obtain the beam measurement result.

4. The method according to claim 1, wherein the result threshold is determined from second configuration information corresponding to the first configuration information.

5. The method according to claim 4, wherein the second configuration information further comprises: a measurement result type;
the performing measurement on the beam to be measured to obtain the beam measurement result comprises:
performing measurement on the beam to be measured to obtain the beam measurement result that conforms to the measurement result type.

6. The method according to claim 4, wherein triggering the measurement reporting or handover according to the beam measurement result and the result threshold comprises:
determining, according to the beam measurement result and the result threshold, that a target result event occurs; and
triggering the measurement reporting or handover according to the target result event.

7. The method according to claim 6, wherein the second configuration information further comprises at least one of a counting threshold or a timer; and
wherein the triggering the measurement reporting or handover according to the target result event comprises any one of:
directly triggering the measurement reporting or handover according to the target result event;
triggering the measurement reporting or handover according to the target result event and the counting threshold;
triggering the measurement reporting or handover according to the target result event and the timer; or
triggering the measurement reporting or handover according to the target result event, the counting threshold, and the timer.

8. The method according to claim 7, wherein triggering the measurement reporting or handover according to the target result event and the counting threshold comprises:
determining a first number of times of occurrence of the target outcome event; and
in response to the first number of times of occurrence reaching the counting threshold, triggering the measurement reporting or handover,
or
wherein triggering the measurement reporting or handover according to the target result event and the timer comprises:
starting the timer; and
in response to that the target result event occurs within a timing period of the timer, triggering the measurement reporting or handover,
or
wherein triggering the measurement reporting or handover according to the target result event, the counting threshold, and the timer comprises:
starting the timer;
counting a second number of times of occurrence of the target result event within a timing period of the timer; and
in response to the second number of times of occurrence reaching the counting threshold, triggering the measurement reporting or handover.

9-10. (canceled)

11. The method according to claim 6, wherein the beam to be measured comprises a serving beam and a reference beam, and correspondingly, the beam measurement result comprises a serving measurement result value of the serving beam and a reference measurement result value of the reference beam.

12. The method according to claim 11, wherein the target result event is any one of the following:
the service measurement result value is less than or equal to a first threshold, and the reference measurement result value is greater than or equal to a second threshold, wherein the first threshold and the second threshold are used as the result threshold;
the reference measurement result value is greater than a sum of the service measurement result value and a third threshold, wherein the third threshold is used as the result threshold; or
the service measurement result value is less than a fourth threshold, wherein the fourth threshold is used as the result threshold.

13. The method according to claim 11, wherein a quantity of the service beams is multiple, and correspondingly, the multiple service beams correspond to multiple service measurement values respectively, wherein
the service measurement result value is the maximum service measurement value among the multiple service measurement values; or
the service measurement result value is an average service measurement value of the multiple service measurement values,
or
wherein a quantity of the reference beams is multiple, and correspondingly, the multiple reference beams correspond to multiple reference measurement values respectively, wherein
the reference measurement result value is the maximum reference measurement value among the multiple reference measurement values; or
the reference measurement result value is an average reference measurement value of the multiple reference measurement values.

14. (canceled)

15. The method according to claim 11, wherein the beam identifier comprises a service beam identifier;
the determining, from the plurality of candidate beams, the candidate beam described by the beam identifier as the beam to be measured comprises:
determining, from the plurality of candidate beams, the candidate beam described by the serving beam identifier as the serving beam;
using other candidate beams except the serving beam among the plurality of candidate beams as reference beams.

16. The method according to claim 1, further comprising:
receiving third configuration information, wherein the third configuration information comprises a correspondence between a first configuration identifier and a second configuration identifier, the first configuration identifier is used to identify the first configuration information, and the second configuration identifier is used to identify second configuration information; and
determining the second configuration information corresponding to the first configuration information according to the correspondence.

17. The method according to claim 1, wherein triggering the measurement reporting or handover according to the beam measurement result and result threshold comprises:
generating a measurement reporting message according to the beam measurement result and the result threshold; and
triggering the measurement reporting or handover according to the measurement reporting message,
wherein the measurement reporting message carries any one of the following:
the beam identifier;
the cell identifier;
a third configuration identifier, wherein the third configuration identifier is used to identify third configuration information, the third configuration information comprises a correspondence between a first configuration identifier and a second configuration identifier, the first configuration identifier is used to identify the first configuration information, and the second configuration identifier is used to identify the second configuration information.

18. (canceled)

19. The method according to claim 1, further comprising:
receiving fourth configuration information, wherein the fourth configuration information comprises: a target cell identifier, the beam identifier, and access information corresponding to the target cell identifier and the beam identifier;
wherein triggering the measurement reporting or handover comprises:
initiating handover to a target cell indicated by the target cell identifier according to the access information in the fourth configuration information.

20. A mobility management method, applied to a network device, the method comprising:
sending first configuration information to a terminal device, wherein the first configuration information comprises a beam identifier; and
in response to measurement reporting or handover of the terminal device, triggering a cell handover for the terminal device,
wherein the measurement reporting or handover is triggered by the terminal device based on a beam measurement result and a result threshold, the beam measurement result is obtained by the terminal device performing measurement on a beam to be measured, and the beam to be measured is determined by the beam identifier.

21. The method according to claim 20, wherein the first configuration information further comprises a reference signal type, and the beam to be measured has a plurality of corresponding candidate signal types;
the beam measurement result is obtained by the terminal device performing measurement on a reference signal described by a candidate signal type matching the reference signal type in the beam to be measured.

22. The method according to claim 20, wherein the result threshold is determined from second configuration information corresponding to the first configuration information, and the method further comprises:
sending third configuration information to the terminal device wherein the third configuration information comprises a correspondence between a first configuration identifier and a second configuration identifier, the first configuration identifier is used to identify the first configuration information, the second configuration identifier is used to identify the second configuration information, and the correspondence is used to determine the second configuration information corresponding to the first configuration information.

23-26. (canceled)

27. The method according to claim 20, further comprising:
sending fourth configuration information to the terminal device, wherein the fourth configuration information comprises the target cell identifier, the beam identifier, and access information corresponding to the target cell identifier and the beam identifier, and the access information is used to trigger the terminal device to initiate handover to a target cell to which the target cell identifier belongs.

28-29. (canceled)

30. A communication apparatus, comprising:
a processor; and
a memory storing instructions executable b by the processor,
wherein the processor is configured to:
receive first configuration information, wherein the first configuration information comprises a beam identifier;
determine a beam to be measured according to the beam identifier;
perform measurement on the beam to be measured to obtain a beam measurement result; and
trigger measurement reporting or handover according to the beam measurement result and a result threshold.

31. A communication apparatus, comprising:
a processor; and
a memory storing instructions executable by the processor,
wherein the processor is configured to perform the method according to claim 20.

32-35. (canceled)
